(19) United States
(12) Patent Application Publication
(10) Pub. No.: US 2021/0380151 A1
(43) Pub. Date: Dec. 9, 2021

(54) Modular Toolbox And Table Assembly

(71) Applicant: Charles Grossman, Largo, FL (US)

(72) Inventor: Charles Grossman, Largo, FL (US)

(21) Appl. No.: 16/895,397

(22) Filed: Jun. 8, 2020

(51) Int. Cl. B62B 1/12; B62B 1/16; B62B 5/06; A47B 85/06; B65D 43/16; B25H 3/02

(52) U.S. Cl. CPC B62B 1/12; B62B 1/16; B25H 3/02; A47B 85/06; B65D 43/16; B62B 5/06

(57) ABSTRACT

A modular toolbox and table assembly for storing and transporting tools includes a toolbox that has an interior space for storing tools. A lid is hingedly coupled to the toolbox for opening and closing the toolbox. A cart is provided that removably engages the tool box for transporting the tool box. The cart is convertible into a table thereby facilitating the tool box to be positioned thereon to make the tool box more easily accessible to a user. The cart has a locking mechanism that is movably coupled to the cart and the locking mechanism releasably engages the tool box for attaching the cart to the toolbox.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toolbox devices and more particularly pertains to a new toolbox device for storing and transporting tools.

### (2) Description of Related Art Including Information Disclosed Under 37 CFR 1.97 and 1.98

The prior art relates to toolbox devices including a tool box that includes wheels and a table top. The prior art discloses a toolbox that has a cart integrated therein and a table top. The prior art discloses a modular toolbox that includes a plurality of rollers and table top. The prior art discloses a toolbox which includes a plurality of cubby slots and a table top. Additionally, the prior art discloses a toolbox that has a cart integrated thereto for transporting the toolbox. The prior art discloses a toolbox that includes wheels and a handle for rolling the toolbox.

### BRIEF SUMMARY OF THE INVENTION

An embodiment of the disclosure meets the needs presented above by generally comprising a toolbox that has an interior space for storing tools. A lid is hingedly coupled to the toolbox for opening and closing the toolbox. A cart is provided that removably engages the tool box for transporting the tool box. The cart is convertible into a table thereby facilitating the tool box to be positioned thereon to make the tool box more easily accessible to a user. The cart has a locking mechanism that is movably coupled to the cart and the locking mechanism releasably engages the tool box for attaching the cart to the toolbox.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a modular toolbox and table assembly according to an embodiment of the disclosure.

FIG. 2 is a bottom perspective view of a toolbox of an embodiment of the disclosure.

FIG. 3 is a top perspective view of a toolbox of an embodiment of the disclosure.

FIG. 4 is a back view of a toolbox of an embodiment of the disclosure.

FIG. 5 is a front view of a toolbox of an embodiment of the disclosure.

FIG. 6 is a left side view of a toolbox of an embodiment of the disclosure.

FIG. 7 is a top view of a toolbox an embodiment of the disclosure.

FIG. 8 is a bottom view of a toolbox of an embodiment of the disclosure.

FIG. 9 is a top front side perspective view of an interior of a toolbox of an embodiment of the disclosure.

FIG. 10 is a perspective view of a cart of an embodiment of the disclosure.

FIG. 11 is a back view of a cart of an embodiment of the disclosure.

FIG. 12 is a left side view of a cart of an embodiment of the disclosure.

FIG. 13 is a top view of a cart of an embodiment of the disclosure.

FIG. 14 is a perspective view of a cart having first legs and second legs in a deployed position to define a table.

FIG. 15 is an exploded perspective view of a cart of an embodiment of the disclosure.

FIG. 16 is an exploded perspective view of a second leg and an outward member of a frame.

FIG. 17 is a perspective view of a collar of an embodiment of the disclosure in a locking position.

FIG. 18 is a perspective view of a collar of an embodiment of the disclosure in an unlocked position.

FIG. 19 is a back perspective view of a lip on a panel of an embodiment of the disclosure.

FIG. 20 is a detailed perspective view of a back of an embodiment of the disclosure.

### DETAILED DESCRIPTION OF THE INVENTION

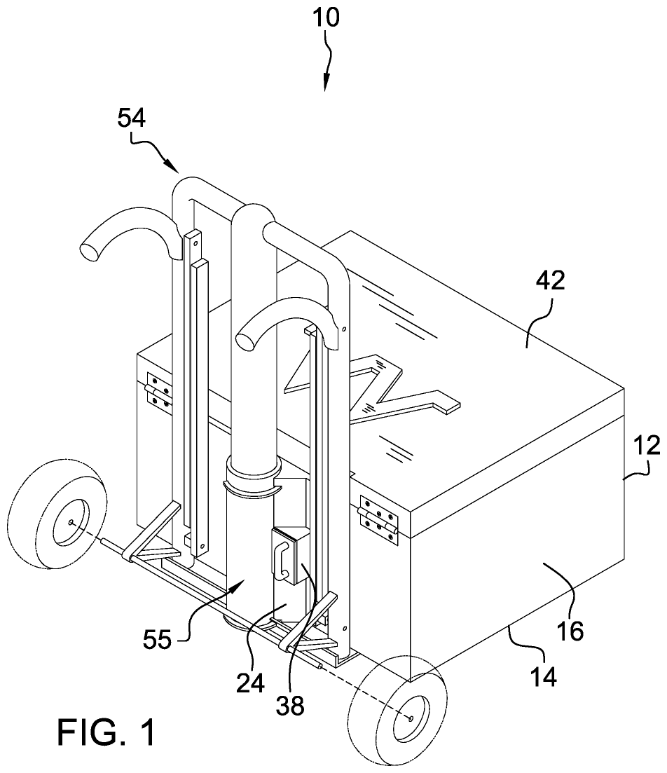

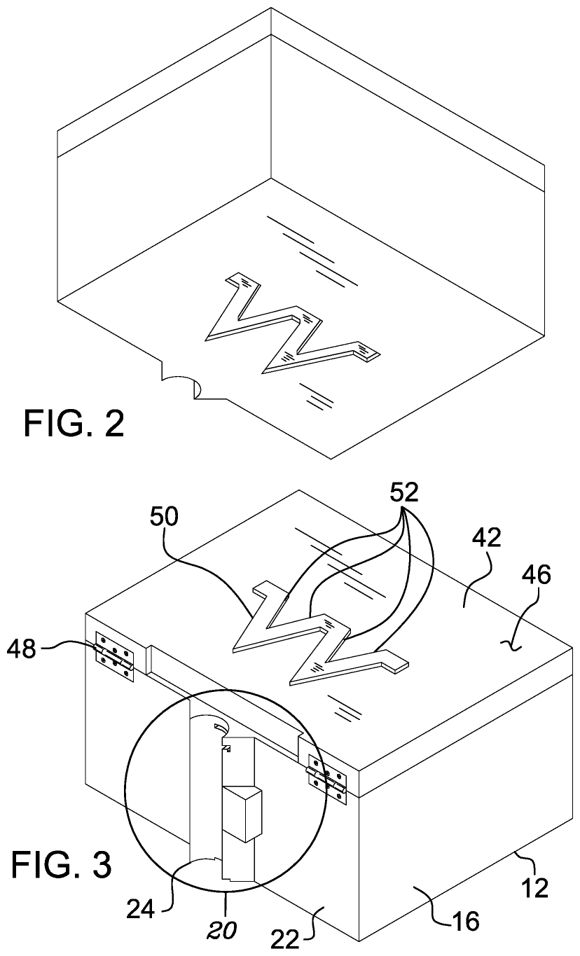

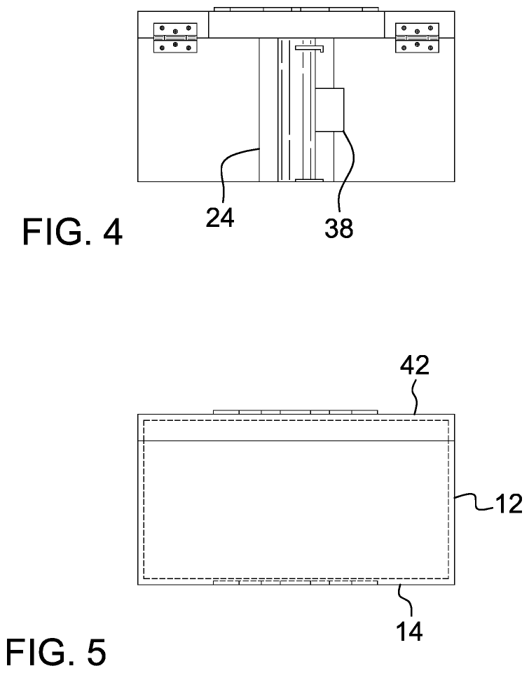

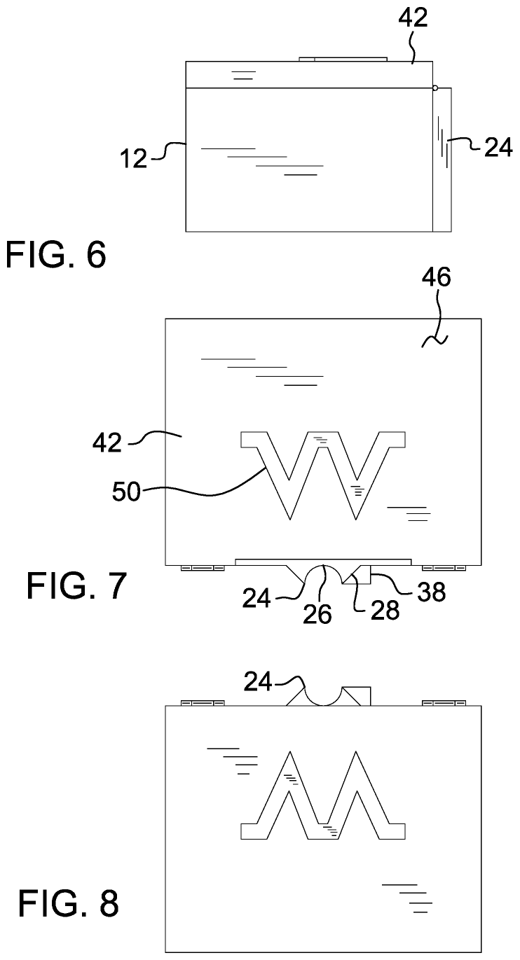

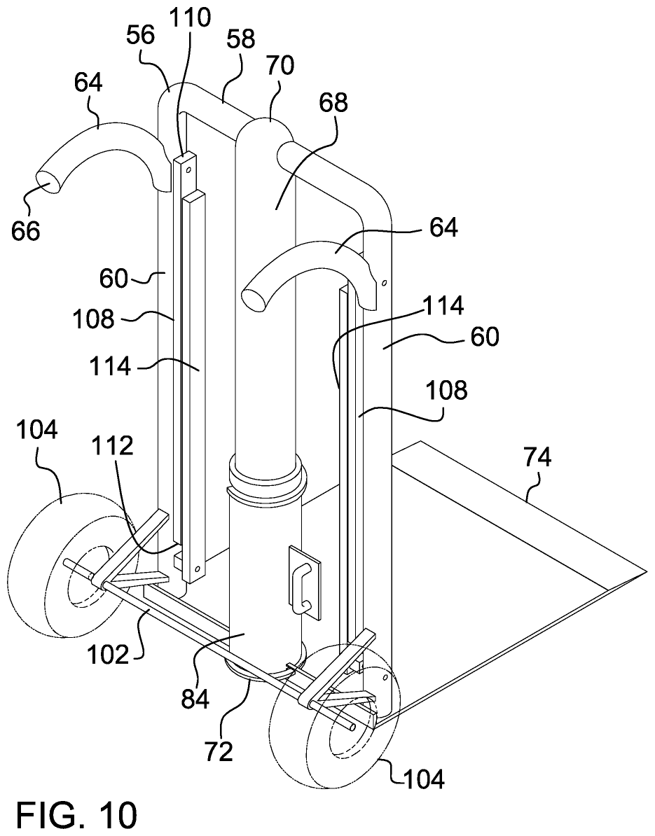

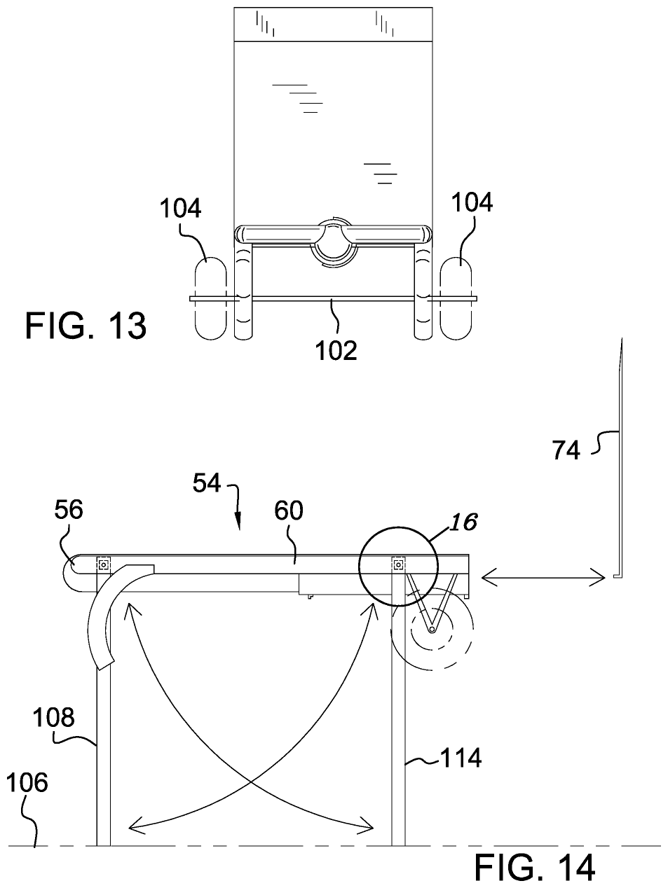

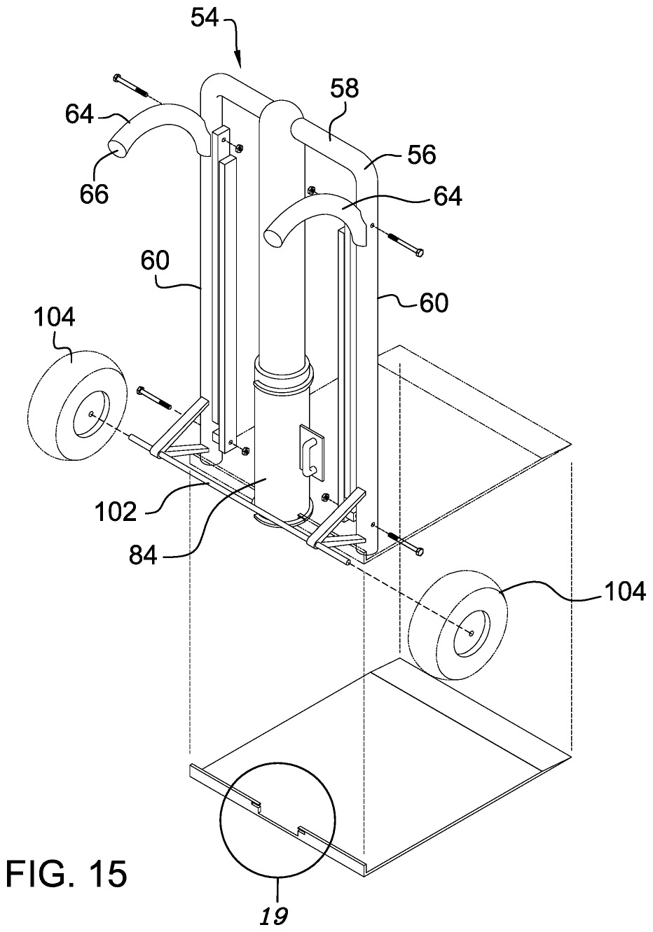

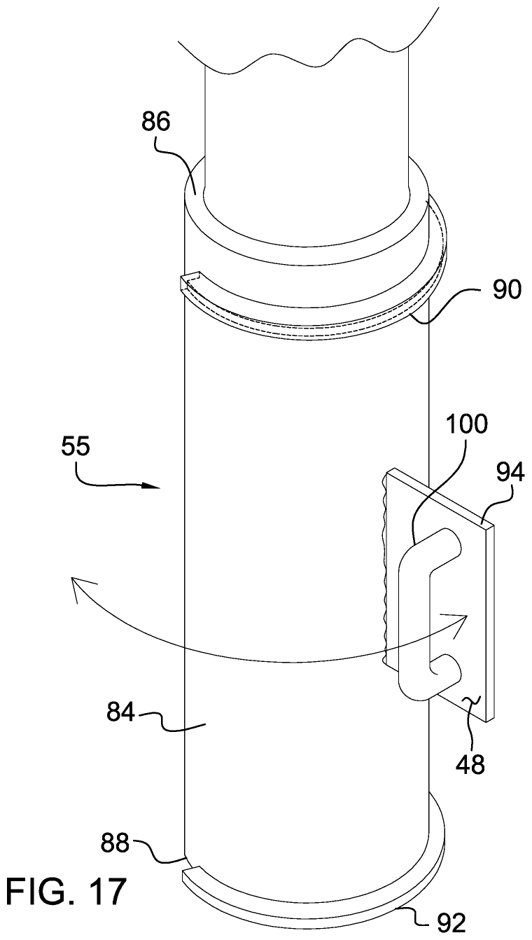

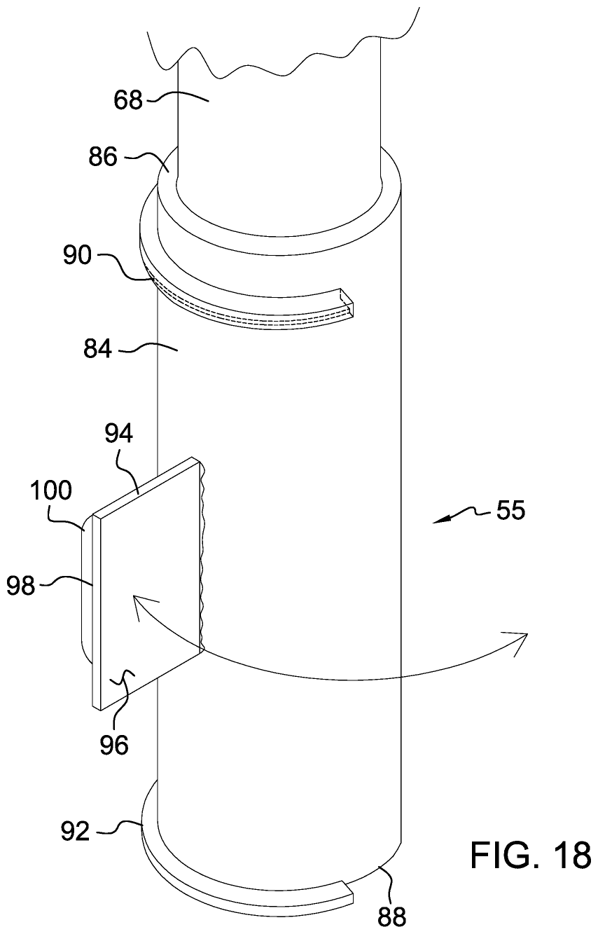

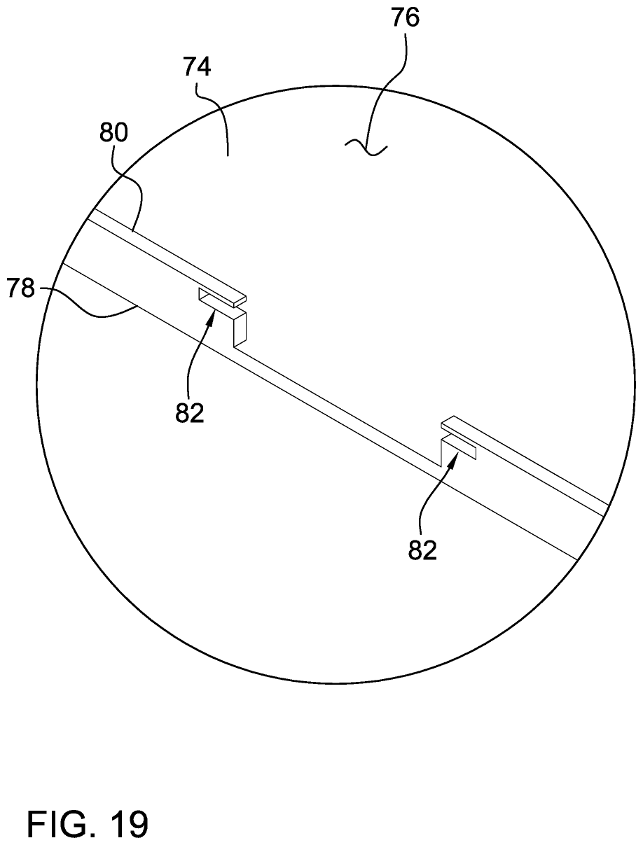

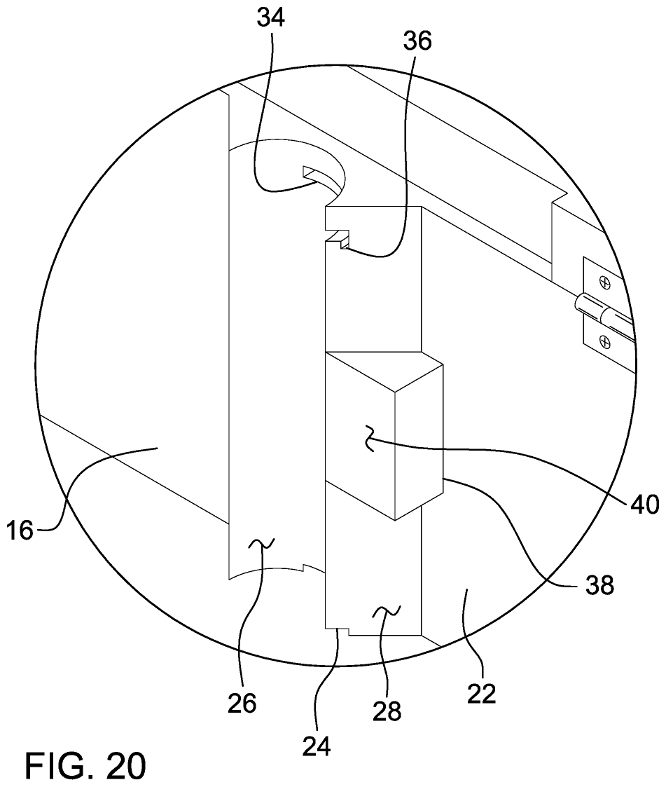

With reference now to the drawings, and in particular to FIGS. 1 through 20 thereof, a new toolbox device embodying the principles and concepts of an embodiment of the disclosure and generally designated by the reference numeral 10 will be described.

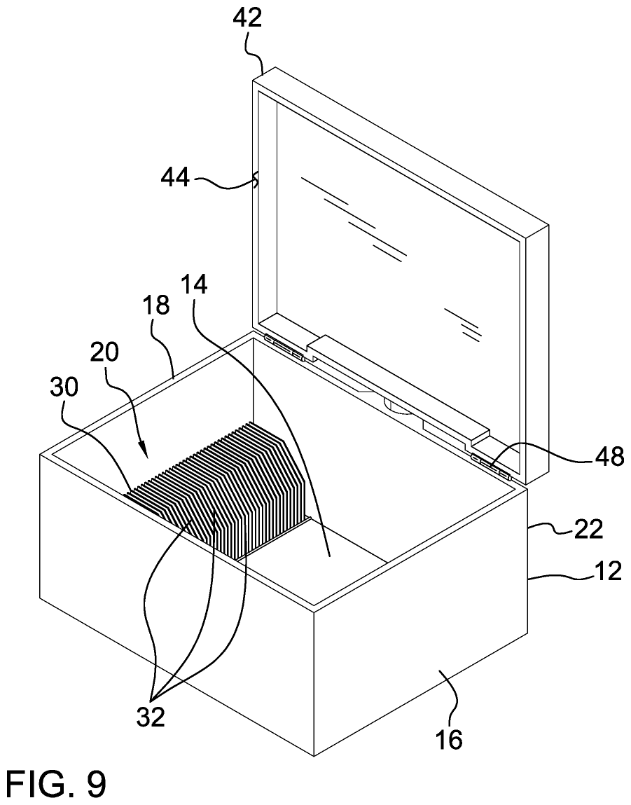

As best illustrated in FIGS. 1 through 20, the modular toolbox and table assembly 10 generally comprises a toolbox 12 that has an interior space for storing tools. The toolbox 12 has a bottom wall 14 and an outer wall 16 extending upwardly therefrom, and the bottom wall 14 has a distal edge 18 with respect to the bottom wall 14 defining an opening 20 into the toolbox 12. The outer wall 16 has a back side 22 and the back side 22 has a trough 24 extending between the distal edge 18 of the outer wall 16 and the bottom wall 14. The trough 24 has a central bounding surface 26 and a lateral bounding surface 28 angling outwardly between the central bounding surface 26 and the back wall. Moreover, the central bounding surface 26 is concavely arcuate with respect to the back side 22 of the outer wall 16. As is most clearly shown in FIG. 9, a block 30 is positioned within the toolbox 12 and the block 30 has a plurality of slots 32 therein for receiving, and subsequently storing, a plurality of circular saw blades.

The central bounding surface 26 has a keyway 34 extending therein toward the back side 22 of the outer wall 16 of the toolbox 12 and the keyway 34 is oriented to extend along a horizontal axis. The keyway 34 extends through the lateral bounding surface 28 and the keyway 34 is positioned proximate the distal edge 18 of the outer wall 16 of the toolbox 12. The keyway 34 has a locking portion 36 extending downwardly along the lateral bounding surface 28. The trough 24 has a block 38 extending away from the lateral bounding surface 28. The block 38 has a rear surface 40 lying on a plane that is oriented coplanar with the back side 22 of the outer wall 16 of the toolbox 12.

A lid 42 is hingedly coupled to the toolbox 12 for opening and closing the toolbox 12. The lid 42 has a bottom surface 44, a top surface 46 and a rear edge 48, and the rear edge 48 is hingedly coupled to the distal edge 18 of the outer wall 16 of the toolbox 12. The bottom surface 44 rests on the distal edge 18 when the lid 42 is closed and the top surface 46 has a prominence 50 thereon. The prominence 50 has a plurality of intersecting sections 52 such that the prominence 50 has the appearance of the letter “W”.

A cart 54 is included and the cart 54 removably engages the tool box for transporting the tool box. Additionally, the cart 54 is convertible into a table thereby facilitating the tool box to be positioned thereon. In this way the tool box is more easily accessible to a user. The cart 54 has a locking mechanism 55 that is movably coupled to the cart 54 and the locking mechanism 55 releasably engages the toolbox 12 for attaching the cart 54 to the toolbox 12.

The cart 54 comprises a frame 56 that has a central member 58 extending between a pair of outward members 60 and each of the outward members 60 has a distal end 62 with respect to the central member 58. A pair of handles 64 is each coupled to and extends rearwardly from a respective one of the outward members 60 for gripping. Each of the handles 64 has a distal end 66 with respect to the respective outward member 60 and each of the handles 64 is curved downwardly between the respective outward member 60 and the distal end 66 of the handles 64.

The cart 54 includes a pipe 68 that has an upper end 70 and a lower end 72, and the upper end 70 is coupled to the central member 58 of the frame 56 has the pipe 68 is centrally positioned between the outward members 60. The cart 54 includes a panel 74 that has a top surface 76 and a back edge 78, and the top surface 46 has a lip 80 extending upwardly therefrom. The lip 80 is aligned with the back edge and the lip 80 has a slot 82 extending therethrough.

The locking mechanism 55 includes a collar 84 that is rotatably positioned around the pipe 68. The collar 84 has a top edge 86 and a bottom edge 88, the bottom edge 88 is aligned with the lower end 72 of the pipe 68 and the top edge 86 is positioned between the lower end 72 and the upper end 70 of the pipe 68. The collar 84 has a first key 90 extending partially around the collar 84 and the first key 90 is spaced from the top edge 86. The collar 84 has a second key 92 extending partially around the collar 84 and the second key 92 is aligned with the bottom edge 88.

The first key 90 engages the keyway 34 in the trough 24 when the collar 84 is rotated into a locking position thereby attaching the toolbox 12 to the cart 54. The first key 90 disengages the keyway 34 in the trough 24 when the collar 84 is rotated into an unlocked position for removing the toolbox 12 from the cart 54. The second key 92 engages the slot 82 in the lip 80 on the panel 74 when the collar 84 is rotated into the locking position. In this way the panel 74 is attached to the cart 54 having the panel 74 lying on a plane that is oriented perpendicular to a longitudinal axis of the outward members 60. The toolbox 12 rests on the panel 74 thereby facilitating the cart 54 to transport the toolbox 12.

The cart 54 includes a plate 94 that is coupled to and extends laterally away from an outer surface 96 of the collar 84. The plate 94 has a back surface 96 and a front surface 98, and the back surface 96 abuts the rear surface 40 of the block 38 on the trough 24 when the collar 84 is rotated into the locking position. The cart 54 includes a handle 100 that is coupled to the front surface 98 of the plate 94 for gripping and urging the collar 84 between the locked position and the unlocked position. The cart 54 includes an axle 102 that is coupled to and extends across each of the outward members 60 of the frame 56 and the axle 102 is positioned adjacent to the distal end 62 of each of the outward members 60. The cart 54 includes a pair of wheels 104 that is each removably coupled to the axle 102 to roll along a support surface 106 for transporting the toolbox 12.

A pair of first legs 108 is provided and each of the first legs 108 has an upper end 110 and a lower end 112. The upper end 110 of each of the first legs 108 is pivotally coupled to a respective one of the outward members 60 of the frame 56. Each of the first legs 108 is positionable in a stored position having each of the first legs 108 being oriented collinear with the respective outward member 60. Moreover, each of the first legs 108 is positionable in a deployed position having each of the first legs 108 being oriented perpendicular to the respective outward member 60. In this way the lower end 112 of each of the first legs 108 abuts the support surface 106 for supporting the frame 56 above the support surface 106.

A pair of second legs 114 is provided and each of the second legs 114 has an upper end 116 and a lower end 118. The lower end 118 of each of the second legs 114 is pivotally coupled to a respective one of the outward members 60 of the frame 56. Each of the second legs 114 is positionable in a stored position having each of the second legs 114 being oriented collinear with the respective outward member 60. Each of the second legs 114 is positionable in a deployed position having each of the second legs 114 being oriented perpendicular with the respective outward member 60. In this way the lower end 118 of each of the second legs 114 abuts the support surface 106 for supporting the frame 56 above the support surface 106.

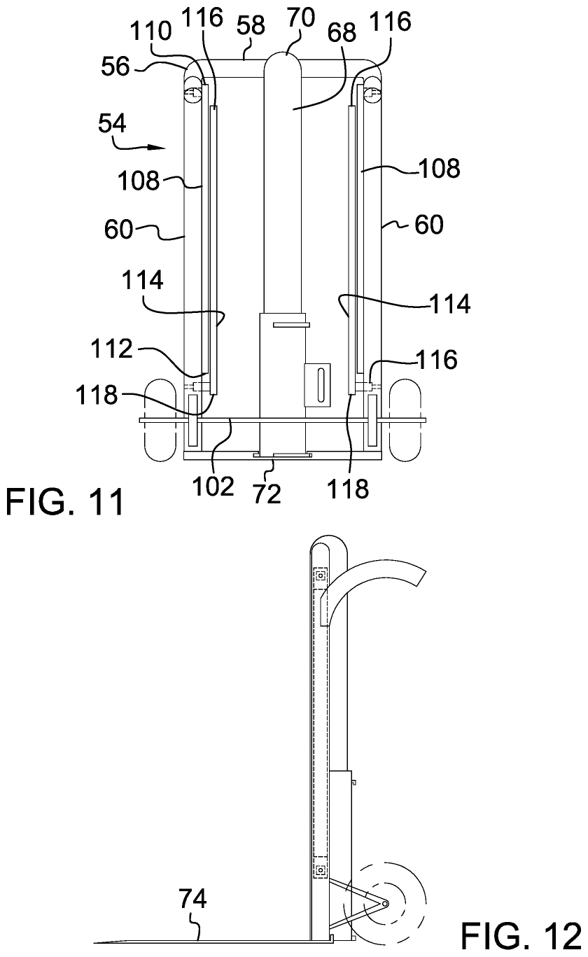

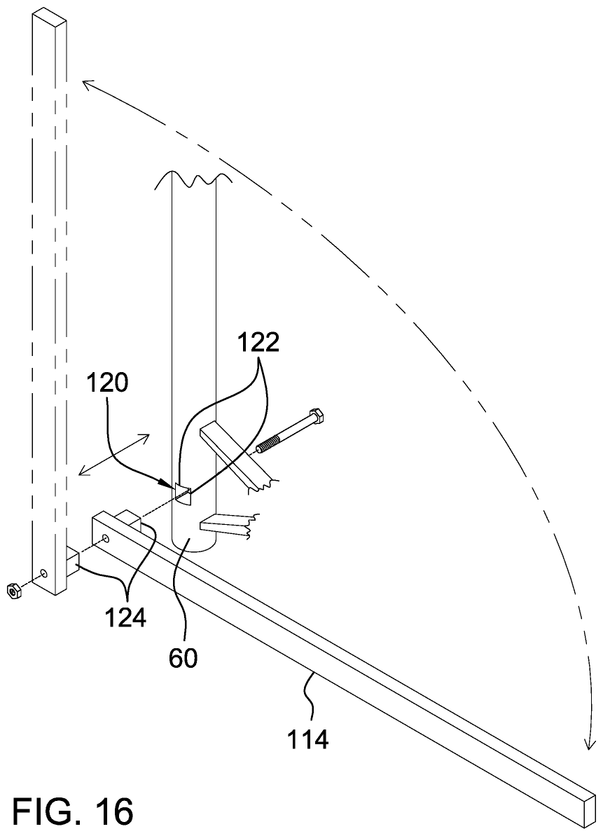

As is most clearly shown in FIGS. 11 and 16, each of the outward members 60 of the frame 56 has a plurality of openings 120 extending therethrough and each of the openings 120 has a plurality of intersecting edges 122. Each of the first legs 108 and the second legs 114 has a tab 124 extending away therefrom. The tab 124 on each of the first legs 108 and the second legs 114 engages a respective one of the openings 120 to inhibit the first legs 108 and the second legs 114 from rotating. In this way each of the first legs 108 and the second legs 114 is retained in either the stored position or the deployed position.

In use, the tool box is positioned on the panel 74 and each of the toolbox 12 and the panel 74 is positioned to abut the frame 56. The collar 84 is rotated into the locking position for attaching the toolbox 12 and the panel 74 to the frame 56. In this way the toolbox 12 can be transported on the cart 54 to a desired location. The collar 84 is rotated into the unlocked position to remove the toolbox 12 and the panel 74 from the frame 56. Additionally, each of the first legs 108 and the second legs 114 are positioned in the deployed position. In this way the frame 56 can be stood upon the support surface 106 thereby facilitating the toolbox 12 to be placed upon the frame 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular toolbox and table assembly for transporting a toolbox to a worksite along with a table to define a work space, said assembly comprising:
a toolbox having an interior space for storing tools;
a lid being hingedly coupled to said toolbox for opening and closing said toolbox;
and
a cart removably engaging said tool box for transporting said tool box, said cart being convertible into a table thereby facilitating said tool box to be positioned thereon wherein said tool box is configured to be more easily accessible to a user, said cart having a locking mechanism being movably coupled to said cart, said locking mechanism releasably engaging said tool box for attaching said cart to said toolbox.

2. The assembly according to claim 1, further comprising said toolbox having a bottom wall and an outer wall extending upwardly therefrom, said bottom wall having a distal edge with respect to said bottom wall, said distal edge defining an opening into said toolbox, said outer wall having a back side, said back side having a trough extending between said distal edge of said outer wall and said bottom wall, said trough having a central bounding surface and a lateral bounding surface angling outwardly between said central bounding surface and said back wall, said central bounding surface being concavely arcuate with respect to said back side of said outer wall.

3. The assembly according to claim 2, wherein said central bounding surface has a keyway extending therein toward said back side of said outer wall of said toolbox, said keyway being oriented to extend along a horizontal axis, said keyway extending through said lateral bounding surface, said keyway being positioned proximate said distal edge of said outer wall of said toolbox, said keyway having a locking portion extending downwardly along said lateral bounding surface.

4. The assembly according to claim 2, wherein said trough has a block extending away from said lateral bounding surface, said block having a rear surface lying on a plane being oriented coplanar with said back side of said outer wall of said toolbox.

5. The assembly according to claim 2, wherein said lid has a bottom surface, a top surface and a rear edge, said rear edge being hingedly coupled to said distal edge of said outer wall of said toolbox, said bottom surface resting on said distal edge when said lid is closed, said top surface having a prominence thereon, said prominence having a plurality of intersecting sections such that said prominence has the appearance of the letter “W”.

6. The assembly according to claim 1, wherein said cart comprises a frame having a central member extending between a pair of outward members, each of said outward members having a distal end with respect to said central member.

7. The assembly according to claim 6, further comprising a pair of handles, each of said handles being coupled to and extending rearwardly from a respective one of said outward members wherein each of said handles is configured to be gripped, each of said handles having a distal end with respect to said respective outward member, each of said handles being curved downwardly between said respective outward member and said distal end of said handles.

8. The assembly according to claim 6, wherein said cart includes a pipe having an upper end and a lower end, said upper end being coupled to said central member of said frame having said pipe being centrally positioned between said outward members.

9. The assembly according to claim 1, wherein said cart includes a panel having a top surface and a back edge, said top surface having a lip extending upwardly therefrom, said lip being aligned with said back edge, said lip having a slot extending therethrough.

10. The assembly according to claim 6, wherein said cart includes a collar being rotatably positioned around said pipe, said collar having a top edge and a bottom edge, said bottom edge being aligned with said lower end of said pipe, said top edge being positioned between said lower end and said upper end of said pipe.

11. The assembly according to claim 10, wherein:
said cart includes a trough having a first keyway therein; and
said collar has a first key extending partially around said collar, said first key being spaced from said top edge, said first key engaging said keyway in said trough when said collar is rotated into a locking position thereby attaching said toolbox to said cart, said first key disengaging said keyway in said trough when said collar is rotated into an unlocked position thereby facilitating said toolbox to be removed from said cart.

12. The assembly according to claim 11, wherein:
said cart includes a panel having a lip and a slot extending through said lip; and
said collar has a second key extending partially around said collar, said second key being aligned with said bottom edge, said second key engaging said slot in said lip on said panel when said collar is rotated into said locking position thereby attaching said panel to said cart having said panel lying on a plane being oriented perpendicular to a longitudinal axis of said outward members.

13. The assembly according to claim 10, wherein said cart includes a plate being coupled to and extending laterally away from an outer surface of said collar, said plate having a back surface and a front surface, said back surface abutting said rear surface of said block on said trough when said collar is rotated into said locking position.

14. The assembly according to claim 13, wherein said cart includes a handle being coupled to said front surface of said plate for gripping and urging said collar between said locked position and said unlocked position.

15. The assembly according to claim 6, wherein said cart includes an axle being coupled to and extending across each of said outward members of said frame, said axle being positioned adjacent to said distal end of each of said outward members.

16. The assembly according to claim 15, wherein said cart includes a pair of wheels, each of said wheels being removably coupled to said axle wherein each of said wheels is configured to roll along a support surface for transporting said toolbox.

17. The assembly according to claim 6, wherein said cart includes a pair of first legs, each of said first legs having an upper end and a lower end, said upper end of each of said first legs being pivotally coupled to a respective one of said outward members of said frame, each of said first legs being positionable in a stored position having each of said first legs being oriented collinear with said respective outward member, each of said first legs being positionable in a deployed position having each of said first legs being oriented perpendicular to said respective outward member wherein said lower end of each of said first legs is configured to abut a support surface for supporting said frame above the support surface.

18. The assembly according to claim 17, wherein said cart includes a pair of second legs, each of said second legs having an upper end and a lower end, said lower end of each of said second legs being pivotally coupled to a respective one of said outward members of said frame, each of said second legs being positionable in a stored position having each of said second legs being oriented collinear with said respective outward member, each of said second legs being positionable in a deployed position having each of said second legs being oriented perpendicular with said respective outward member wherein said lower end of each of said second legs is configured to abut the support surface for supporting said frame above the support surface.

19. A modular toolbox and table assembly for transporting a toolbox to a worksite along with a table to define a work space, said assembly comprising:
a toolbox having an interior space for storing tools, said toolbox having a bottom wall and an outer wall extending upwardly therefrom, said bottom wall having a distal edge with respect to said bottom wall, said distal edge defining an opening into said toolbox, said outer wall having a back side, said back side having a trough extending between said distal edge of said outer wall and said bottom wall, said trough having a central bounding surface and a lateral bounding surface angling outwardly between said central bounding surface and said back wall, said central bounding surface being concavely arcuate with respect to said back side of said outer wall, said central bounding surface having a keyway extending therein toward said back side of said outer wall of said toolbox, said keyway being oriented to extend along a horizontal axis, said keyway extending through said lateral bounding surface, said keyway being positioned proximate said distal edge of said outer wall of said toolbox, said keyway having a locking portion extending downwardly along said lateral bounding surface, said trough having a block extending away from said lateral bounding surface, said block having a rear surface lying on a plane being oriented coplanar with said back side of said outer wall of said toolbox;
a lid being hingedly coupled to said toolbox for opening and closing said toolbox, said lid having a bottom surface, a top surface and a rear edge, said rear edge being hingedly coupled to said distal edge of said outer wall of said toolbox, said bottom surface resting on said distal edge when said lid is closed, said top surface having a prominence thereon, said prominence having a plurality of intersecting sections such that said prominence has the appearance of the letter “W”; and
a cart removably engaging said tool box for transporting said tool box, said cart being convertible into a table thereby facilitating said tool box to be positioned thereon wherein said tool box is configured to be more easily accessible to a user, said cart having a locking mechanism being movably coupled to said cart, said locking mechanism releasably engaging said tool box for attaching said cart to said toolbox, said cart comprising:
a frame having a central member extending between a pair of outward members, each of said outward members having a distal end with respect to said central member;
a pair of handles, each of said handles being coupled to and extending rearwardly from a respective one of said outward members wherein each of said handles is configured to be gripped, each of said handles having a distal end with respect to said respective outward member, each of said handles being curved downwardly between said respective outward member and said distal end of said handles;
a pipe having an upper end and a lower end, said upper end being coupled to said central member of said frame having said pipe being centrally positioned between said outward members;
a panel having a top surface and a back edge, said top surface having a lip extending upwardly therefrom, said lip being aligned with said back edge, said lip having a slot extending therethrough;
a collar being rotatably positioned around said pipe, said collar having a top edge and a bottom edge, said bottom edge being aligned with said lower end of said pipe, said top edge being positioned between said lower end and said upper end of said pipe, said collar having a first key extending partially around said collar, said first key being spaced from said top edge, said collar having a second key extending partially around said collar, said second key being aligned with said bottom edge, said first key engaging said keyway in said trough when said collar is rotated into a locking position thereby attaching said toolbox to said cart, said first key disengaging said keyway in said trough when said collar is rotated into an unlocked position thereby facilitating said toolbox to be removed from said cart, said second key engaging said slot in said lip on said panel when said collar is rotated into said locking position thereby attaching said panel to said cart having said panel lying on a plane being oriented perpendicular to a longitudinal axis of said outward members;
a plate being coupled to and extending laterally away from an outer surface of said collar, said plate having a back surface and a front surface, said back surface abutting said rear surface of said block on said trough when said collar is rotated into said locking position;
a handle being coupled to said front surface of said plate for gripping and urging said collar between said locked position and said unlocked position;
an axle being coupled to and extending across each of said outward members of said frame, said axle being positioned adjacent to said distal end of each of said outward members;
a pair of wheels, each of said wheels being removably coupled to said axle wherein each of said wheels is configured to roll along a support surface for transporting said toolbox;
a pair of first legs, each of said first legs having an upper end and a lower end, said upper end of each of said first legs being pivotally coupled to a respective one of said outward members of said frame, each of said first legs being positionable in a stored position having each of said first legs being oriented collinear with said respective outward member, each of said first legs being positionable in a deployed position having each of said first legs being oriented perpendicular to said respective outward member wherein said lower end of each of said first legs is configured to abut a support surface for supporting said frame above the support surface; and
a pair of second legs, each of said second legs having an upper end and a lower end, said lower end of each of said second legs being pivotally coupled to a respective one of said outward members of said frame, each of said second legs being positionable in a stored position having each of said second legs being oriented collinear with said respective outward member, each of said second legs being positionable in a deployed position having each of said second legs being oriented perpendicular with said respective outward member wherein said lower end of each of said second legs is configured to abut the support surface for supporting said frame above the support surface.
